(19) United States
(12) Patent Application Publication
(10) Pub. No.: US 2016/0054832 A1
(43) Pub. Date: Feb. 25, 2016

(54) ELECTRONIC DEVICE HAVING TOUCH AREA

(71) Applicant: Samsung Electronics Co., Ltd., Gyeonggi-do (KR)

(72) Inventors: Min Uk Kim, Gyeonggi-do (KR); Dong Sub Kim, Gyeonggi-do (KR); Byeong Cheol Kim, Gyeonggi-do (KR); Hak Yeol Kim, Gyeonggi-do (KR); Hyun Woong Chung, Gyeonggi-do (KR)

(21) Appl. No.: 14/835,267

(22) Filed: Aug. 25, 2015

(30) Foreign Application Priority Data
Aug. 25, 2014 (KR) 10-2014-0111071

(51) Int. Cl. G06F 3/044; G06F 1/16; G06F 3/0488; G06F 3/041

(52) U.S. Cl. CPC G06F 3/044; G06F 3/0412; G06F 1/1652; G06F 3/04883; G06F 2203/04103; G06F 2203/04803; G06F 2203/04102

(57) ABSTRACT

An electronic device includes a window panel, a touch panel of which at least a part is bent to be partitioned into a first touch area or a second touch area, and a display panel. The touch panel includes a driving signal line or a recognition signal line, and each of the first and second touch areas includes at least one of the driving signal line or the recognition signal line.

### CROSS-REFERENCE TO RELATED APPLICATION AND CLAIM OF PRIORITY

The present application is related to and claims benefit under 35 U.S.C. §119(a) of a Korean patent application filed on Aug. 25, 2014 in the Korean Intellectual Property Office and assigned Serial number 10-2014-0111071, the entire disclosure of which is hereby incorporated by reference.

### TECHNICAL FIELD

The present disclosure relate to an electronic device having a touch area.

### BACKGROUND

An electronic device recognizes a touch operation of a user and performs a function corresponding to the touch operation. The electronic device includes a touch area at a front surface of the electronic device and includes a bezel area surrounding a front touch area. The bezel area is an area that includes interconnections for driving a touch panel or a display panel.

An electronic device includes a bezel area at a front surface so that touch performance on a touch area adjacent to the bezel is lowered. Furthermore, since the touch area is disposed only at the front surface of the electronic device, the electronic device has a limit to use its side space efficiently.

### SUMMARY

Aspects of the present disclosure are to address at least the above-mentioned problems and/or disadvantages and to provide at least the advantages described below. To address the above-discussed deficiencies, it is a primary object to provide an electronic device having an expanded touch area.

In accordance with an the present disclosure, an electronic device is provided. The electronic device may include a window panel, a touch panel of which at least a part is bent to be partitioned into a first touch area and a second touch area, and a display panel. The touch panel may include a driving signal line or a recognition signal line, and each of the first and second touch areas may include at least one of the driving signal line or the recognition signal line.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including an electronic device according to various embodiments of the present disclosure;

FIGS. 2A and 2B (together referred to as FIG. 2) illustrate an electronic device including a side touch area according to various embodiments of the present disclosure;

FIGS. 3A and 3B illustrate a touch panel including a signal line for touch recognition according to various embodiments of the present disclosure;

FIG. 4 illustrates a touch panel in which a width or thickness of a signal line is varied according to various embodiments of the present disclosure;

FIG. 5 illustrates a cross-sectional view of an electronic device including a case unit having a step construction according to various embodiments of the present disclosure;

FIGS. 6A and 6B (together referred to as FIG. 6) illustrate a cross-sectional view of an electronic device including a shielding member according to various embodiments of the present disclosure;

FIG. 7 illustrates a touch panel in which a part of a side touch area is restricted according to various embodiments of the present disclosure;

FIG. 8 illustrates a touch panel in which signal lines are expanded into a bending area according to various embodiments of the present disclosure;

FIG. 9 illustrates an example utilization of an electronic device including a side touch area according to various embodiments of the present disclosure; and

FIG. 10 illustrates an electronic device according to various embodiments of the present disclosure.

Throughout the drawings, it should be noted that like reference numbers are used to depict the same or similar elements, features, and structures.

### DETAILED DESCRIPTION

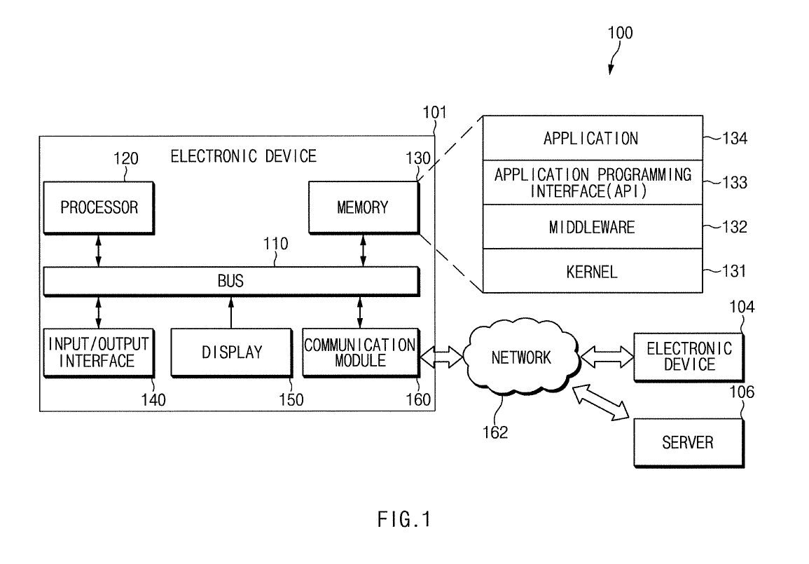

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar components may be marked by similar reference numerals.

The term “include,” “comprise,” “including,” or “comprising” used herein indicates disclosed functions, operations, or existence of elements but does not exclude other functions, operations or elements. It should be further understood that the term “include”, “comprise”, “have”, “including”, “comprising”, or “having” used herein specifies the presence of stated features, integers, operations, elements, components, or combinations thereof but does not preclude the presence or addition of one or more other features, integers, operations, elements, components, or combinations thereof.

The meaning of the term “or” used herein includes any combination of words listed together with the term. For example, the expression “A or B” may indicate A, B, or both A and B.

The terms, such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present disclosure, a first element may be referred to as a second element, and similarly, a second element may be referred to as a first element.

In the description below, when one part (or element, device, etc.) is referred to as being “connected” to another part (or element, device, etc.), it should be understood that the former can be “directly connected” to the latter, or “electrically connected” to the latter via an intervening part (or element, device, etc.). It will be further understood that when one component is referred to as being “directly connected” or “directly linked” to another component, it means that no intervening component is present.

Terms used in this specification are used to describe embodiments of the present disclosure and are not intended to limit the scope of the present disclosure. The terms of a singular form may include plural forms unless otherwise specified.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal sense unless expressly so defined herein in various embodiments of the present disclosure.

Electronic devices according to various embodiments of the present disclosure may include an electronic device having a display function. For example, the electronic devices may include at least one of smartphones, tablet personal computers (PCs), mobile phones, video telephones, electronic book readers, desktop PCs, laptop PCs, netbook computers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to various embodiments of the present disclosure, the electronic devices may be smart home appliances including a display function. The smart home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles, electronic dictionaries, electronic keys, camcorders, electronic picture frames, and the like.

According to various embodiments of the present disclosure, the electronic devices may include at least one of medical devices (e.g., a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), and avionics.

According to various embodiments of the present disclosure, the electronic devices may include at least one of the following electronic devices having a display function: parts of furniture or buildings/structures having communication functions, electronic boards, electronic signature receiving devices, projectors, and measuring instruments (e.g., water meters, electricity meters, gas meters, and wave meters) including metal cases. The electronic devices according to various embodiments of the present disclosure may be one or more combinations of the above-mentioned devices. Furthermore, it would be obvious to those skilled in the art that the electronic devices according to various embodiments of the present disclosure are not limited to the above-mentioned devices.

Hereinafter, electronic devices according to various embodiments of the present disclosure will be described with reference to the accompanying drawings. The term “user” used herein may refer to a person who uses an electronic device or may refer to a device (e.g., an artificial electronic device) that uses an electronic device.

FIG. 1 illustrates a network environment 100 including an electronic device 101 according to various embodiments of the present disclosure. Referring to FIG. 1, an electronic device 101 may include a bus 110, a processor 120, a memory 130, an input/output (I/O) interface 140, a display 150, and a communication module 160.

The bus 110 may interconnect the above-described components and may be a circuit for conveying communications (e.g., a control message) among the above-described components.

The processor 120 may receive, for example, instructions from the above-described other components (e.g., the memory 130, the input/output interface 140, the display 150, the communication module 160, and the like) through the bus 110, may decode the received instructions, and may perform data processing or operations according to the decoded instructions. For example, the processor 120 may receive an instruction, corresponding to a touch input of a user, through the I/O interface 140 and may perform the following functions in response to the received instruction: execution of an application, a screen change, a volume control, and the like.

The memory 130 may store instructions or data received from the processor 120 or other components (e.g., the input/output interface 140, the display 150, the communication module 160, and the like) or generated by the processor 120 or the other components. The memory 130 may include, for example, programming modules such as a kernel 131, a middleware 132, an application programming interface (API) 133, an application 134, and the like. Each of the above-described programming modules may be implemented in the form of software, firmware, hardware, or a combination of at least two thereof.

The kernel 131 may control or manage system resources (e.g., the bus 110, the processor 120, the memory 130, and the like) that are used to execute operations or functions of remaining other programming modules, for example, the middleware 132, the API 133, or the application 134. Furthermore, the kernel 131 may provide an interface that allows the middleware 132, the API 133, or the application 134 to access discrete components of the electronic device 101 so as to control or manage the middleware 132, the API 133, or the application 134.

The middleware 132 may perform a mediation role such that the API 133 or the application 134 communicates with the kernel 131 to exchange data. Furthermore, with regard to task requests received from the application 134, for example, the middle ware 132 may perform a control (e.g., scheduling or load balancing) on a task request using a method of assigning the priority, which makes it possible to use a system resource (e.g., the bus 110, the processor 120, the memory 130, or the like) of the electronic device 101, to the at least one application 134.

The API 133 may be an interface through which the application 134 controls a function provided by the kernel 131 or the middleware 132, and may include, for example, at least one interface or function (e.g., an instruction) for a file control, a window control, image processing, a character control, or the like.

According to various embodiments of the present disclosure, the application 134 may include a short messaging service/multimedia messaging service (SMS/MMS) application, an e-mail application, a calendar application, an alarm application, a health care application (e.g., an application for measuring an exercise amount, a blood sugar or the like), an environment information application (e.g., an application for providing air pressure, humidity, temperature information or the like) or the like. Additionally or generally, the application 134 may be an application associated with information exchange between the electronic device 101 and an external electronic device (e.g., an electronic device 104). The application associated with information exchange may include, for example, a notification relay application for transmitting specific information to an external electronic device or a device management application for managing an external electronic device.

The I/O interface 140 may transmit an instruction or data, input from a user through an input/output device (e.g., a sensor, a keyboard, or a touch screen), to the processor 120, the memory 130, or the communication module 160, for example, through the bus 110. For example, the I/O interface 140 may provide the processor 120 with user's touch data input through a touch screen. In this case, a touch screen may perform a function of the I/O interface 140 and a function of the display 150 at the same time.

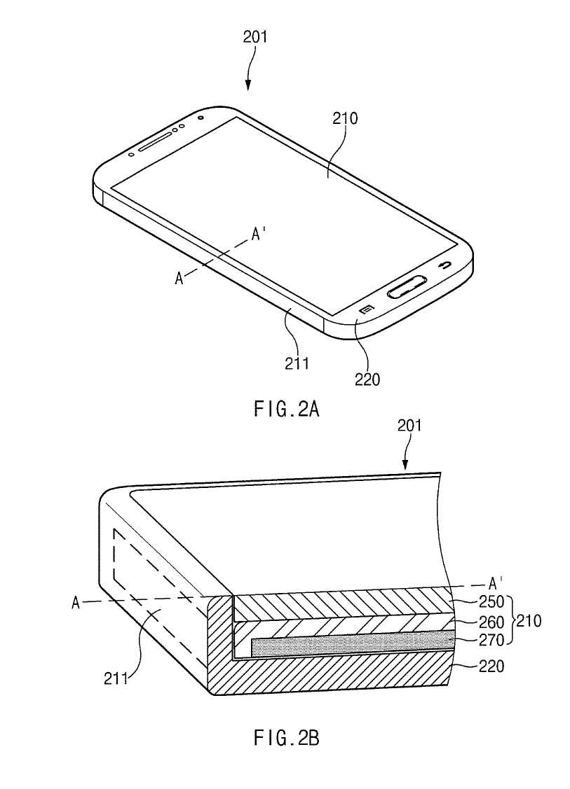

According to various embodiments of the present disclosure, in the case where the I/O interface 140 is implemented with a touch screen, a touch area of the touch screen may be expanded into a side area of the electronic device 101. A user may touch a side of the electronic device 101 to perform a variety of functions such as execution of an application, a cursor movement, a volume control, and the like. Information associated with implementation of a side touch area or a method for using the same may be given with respect to FIGS. 2 to 10.

The I/O interface 140 may output an instruction or data, received from the processor 120, the memory 130, or the communication module 160 through the bus 110, through the input/output device (e.g., a speaker or a display). For example, the I/O interface 140 may output voice data processed through the processor 120 to the user through a speaker.

The display 150 may display a variety of information (e.g., multimedia data, text data, and the like) for the user. The display 150 may perform a function of the I/O interface 140 and a function of the display 150 at the same time.

The communication module 160 may establish communication between the electronic device 101 and an external electronic device (e.g., an electronic device 104 or a server 106). For example, the communication module 160 may be connected to a network 162 through wireless communication or wired communication to communicate with the external electronic device.

FIG. 2 illustrates an electronic device including a side touch area, according to various embodiments of the present disclosure.

Referring to FIG. 2, an electronic device 201 may include a display module 210 and a case unit 220. The display module 210 (e.g., a display 150) may display a variety of information (e.g., multimedia data, text data, or the like) to be provided to a user. Furthermore, the display module 210 may include a sensor capable of detecting (or sensing) a touch of a user. The display module 210 may recognize a proximity touch (e.g., hovering) or a contact touch of the user through the sensor. The display module 210 may provide touch-received command or data to a processor (e.g., AP) in the electronic device 201.

According to various embodiments of the present disclosure, the display module 210 may include a side touch area 211. The side touch area 211 may be implemented by expanding a touch panel (and signal lines included in the touch panel) included in the display module 210. In FIG. 2, an embodiment of the present disclosure is exemplified as the side touch area 211 is implemented at a left side of the electronic device 201. However, the scope and spirit of the present disclosure may not be limited thereto. For example, the side touch area 211 may be implemented at any other side (e.g., a left side, a top side, or a bottom side in a plan view). Information on the implementation and use of the side touch area 211 will be given through FIGS. 2 to 10.

The case unit (or an outer housing) 220 may be implemented in the form of surrounding at least a part of a front surface, a side, or a rear surface of the electronic device 201. The case unit 220 may fasten the display module 210 and may protect a panel or circuit in the electronic device 201. The case unit 220 may be implemented in an injection molding manner or may be implemented by combining front, side, and bottom portions that are separately made. The case unit 220 may be formed of a nonmetallic material (or plastic) or a metallic material.

In the case where a touch area of the display module 210 is expanded into a side, the side portion of the case unit 220 may make it possible to perform a side touch. If a user touches the side portion of the case unit 220, a user's touch may be recognized through an inner touch panel. According to various embodiments of the present disclosure, in the case where a side display is possible, a part of the side portion of the case unit 220 may be implemented with a window panel.

Referring to FIG. 2B, which shows a cross-sectional view taken along a line A-A′, the display module 210 may include a window panel 250, a touch panel 260, and a display panel 270. The display module 210 may be mounted and fixed in the case unit 220.

The window panel 250 may be disposed at the uppermost portion of the display module 210 to protect the touch panel 260 or the display panel 270. The window panel 250 may be formed of glass, poly carbonate (PC), poly methyl meth acrylate (PMMA), polyimide (PI), and the like.

According to various embodiments of the present disclosure, in the case where the electronic device 201 is implemented to perform a side display, the window panel 250 may be also disposed at the side portion of the case unit 220. In this case, the window panel 250 may be implemented such that a front window and a side window are integrated or are independent of each other.

The touch panel 260 may be interposed between the window panel 250 and the display panel 270. The touch panel 260 may be formed of a light transmission material, thereby allowing an image signal, displayed through the display panel 270, to penetrate the touch panel 260.

According to various embodiments of the present disclosure, the touch panel 260 may be formed of a flexible material (e.g., a flexible transparent film), and at least a part thereof may be bent. In the case where the touch panel 260 is bent, the touch panel 260 may be partitioned into a plurality of touch areas. For example, in the case where a front edge portion of the electronic device 201 is bent, the touch panel 260 may be partitioned into a front touch area or a side touch area. Each of the front and side touch areas may include at least one signal line (e.g., a channel) for recognizing a touch operation of a user.

In FIG. 2, an embodiment of the present disclosure is exemplified as the touch panel 260 is bent at a front left edge portion of the electronic device 201. However, the scope and spirit of the present disclosure may not be limited thereto. For example, the touch panel 260 may be bent at any other side (e.g., a right side, a top side, or a bottom side) edge of the electronic device 201.

The display panel 270 may be interposed between the touch panel 260 and a bottom portion of the case unit 220. The display panel 270 may display an image according to an electrical signal in the electronic device 201. The display panel 270 may be implemented with a liquid crystal display (LCD) panel, an organic light emitting diodes (OLED) panel, or the like.

According to various embodiments of the present disclosure, the display panel 270 may be implemented in a flexible form or in the form that a side display is possible. For example, the display panel 270 may be formed of a flexible material and may be bent in the form similar to the touch panel 260. In the case where a front edge portion of the electronic device 201 is bent, the electronic device 201 may include a front display area or a side display area. If a side display is possible, a part of the side portion of the case unit 220 may be implemented with a window panel to provide a user with a signal of the side display panel.

Although not illustrated in FIG. 2, an adhesive layer may exist between the panels. The adhesive layer may prevent the panels from being separated and may be formed of a transparent optical clear adhesive (OCA), resin, or the like. An adhesive layer may exist between the side touch area of the touch panel 260 and the display panel 270, thereby preventing a decrease in a bending angle of the touch panel 260.

According to various embodiments of the present disclosure, an adhesive layer between the touch panel 260 and the display panel 270 may exist only between the front touch area and the display panel 270. An interconnection area of the display panel 270 exists between the side touch area of the touch panel 260 and the display panel 270, so adhesion between the side touch area of the touch panel 260 and the display panel 270 is inappropriate.

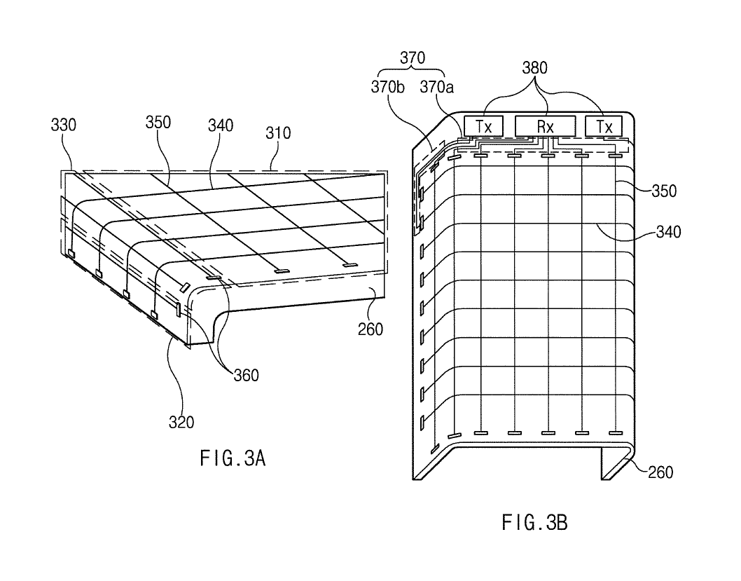

FIG. 3A illustrates a touch panel including a signal line for touch recognition.

Referring to FIG. 3A, a touch panel 260 may be bent because formed of a flexible material (e.g., a flexible transparent film and the like). In this case, the touch panel 260 may include a front touch area 310, a side touch area 320, and a bending area 330. According to various embodiments of the present disclosure, since the whole of the touch panel 260 need not be implemented to be flexible, a specific part (e.g., a part adjacent to an edge of the electronic device 201) which needs to be bent may be implemented in a flexible form.

The front touch area 310 may correspond to a touch area which is disposed parallel with the window panel 250 or the display panel 270 of the electronic device 201. The side touch area 320 may correspond to a touch area that is not parallel with the front touch area 310. According to various embodiments of the present disclosure, the side touch area 320 may be disposed to be perpendicular to the front touch area 310.

The bending area 330 may be interposed between the front touch area 310 and the side touch area 320 and may be an area bent according to a specific curvature. The bending area 330 may connect the front touch area 310 and the side touch area 320 without disconnection. According to various embodiments of the present disclosure, the bending area 330 may include a rounded bending surface. The bending surface may prevent a sensor of the touch panel 260 from being cracked according to the sharp bending of a panel. The bending surface may be smoothly or sharply rounded according to a characteristic of a flexible material, a thickness of the touch panel 260, or the like. The area and shape of the bending area 330 may vary according to a shape of the bending surface. For example, in the case where the bending surface is smoothly rounded, the bending area 330 may be formed relatively widely. In the case where the bending surface is sharply rounded, the bending area 330 may be formed relatively narrowly.

Each touch area may include signal lines for recognizing a touch of a user. The signal lines may include at least one driving signal line 340 or a recognition signal line 350. The driving signal line 340 may be an electrical line arranged in a first direction (e.g., a horizontal direction) of the touch panel 260. The recognition signal line 350 may be an electrical line arranged in a second direction (e.g., a longitudinal direction) of the touch panel 260. The recognition signal line 350 may be formed to cross the driving signal line 340 in a net or matrix form. The driving signal line 340 or the recognition signal line 350 may be connected to a driving module. The driving signal line 340 may supply a specific power through a driving module, and the recognition signal line 350 may provide a driving module with an electrical signal changed by a touch of a user.

A single-layer touch panel 260 may be illustrated in FIG. 3A. According to various embodiments of the present disclosure, the touch panel 260 may include a first layer including the driving signal line 340, a second layer including the recognition signal line 350, and an insulation layer interposed between the first layer and the second layer. The touch panel 260 may be formed such that a first layer including the driving signal line 340 and a second layer including the recognition signal line 350 are sequentially stacked. The driving signal line 340 and the recognition signal line 350 may be spaced apart from each other by a gap corresponding to a thickness of the insulation layer and may constitute a capacitor together with the gap. In the case where capacitance of the capacitor is changed by a touch operation of a user, a change in the capacitance may be converted into an electrical signal, and the electrical signal may be provided to a driving module.

According to various embodiments of the present disclosure, the driving signal line 340 or the recognition signal line 350 may be formed with a metal (e.g., silver, copper, aluminum, and the like) mesh. The metal mesh may be formed of a material capable of being processed to have brittleness of a specific size or less or a tensile force of a specific size or more. Unlike indium tin oxide (ITO) with great brittleness, the metal mesh may not be cracked even at the bending area 330. According to various embodiments of the present disclosure, the driving signal line 340 or the recognition signal line 350 may be implemented using silver nano wire, carbon nano tube, graphene, or the like.

According to various embodiments of the present disclosure, the driving signal line 340 or the recognition signal line 350 may be connected to a pad 360 which is formed at an end of a signal line thereof. The pad 360 may fix each signal line and may be used as a connection portion for transmitting an electrical signal generated according to a touch operation. The pad 360 may be implemented with the same material as a corresponding line or with a material having electrical conductivity greater than that of a corresponding line.

FIG. 3B illustrates a touch panel 220 of which the signal lines are electrically connected.

Referring to FIG. 3B, a touch panel 260 may further include an interconnection area 370. The interconnection area 370 may include an interconnection for connecting a pad 360 formed at an end of a line for a sensor and a driving module 380 of a flexible printed circuit board (FPCB). A change in an electrical signal due to a touch of a user may be provided to the driving module 380 through a pad 360, which is connected to each line 340, 350, and an interconnection. The interconnection area 370 for electrical connection may be a black matrix (BM) area where it is impossible to recognize a touch.

The interconnection area 370 may include a front interconnection area 370a and a side interconnection area 370b. The front interconnection area 370a may be connected to signal lines included in a front touch area 310. The side interconnection area 370b may be connected to signal lines included in a side touch area 320. In the case where a left edge and a right edge of the touch panel 260 all are bent as illustrated in FIG. 3B, the side interconnection area 370b may be disposed at each of the left and right of the touch panel 260. In this case, a part of the driving signal line 340 may be connected to the driving module 380 through a right interconnection area, and the rest thereof may be connected to the driving module 380 through a left interconnection area.

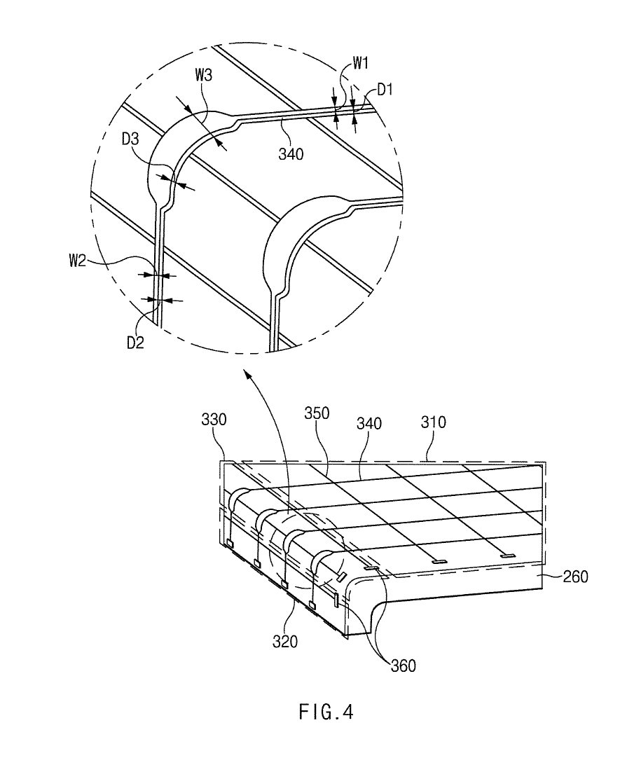

FIG. 4 illustrates a touch panel in which a width or thickness of a signal line is varied.

Referring to FIG. 4, each of a front touch area 310, a side touch area 320, and a bending area 330 may include a signal line for recognizing a touch operation of a user. The signal line may include a driving signal line 340 or a recognition signal line 350. As illustrated in FIG. 4, in the case where the touch panel 230 is bent in a progressive direction of the driving signal line 340, the driving signal line 340 may be formed to cross the front touch area 310, the side touch area 320, and the bending area 330. In contrast, the driving signal line 340 may be formed at each of the front touch area 310, the side touch area 320, and the bending area 330.

The driving signal line 340 may be implemented to have different widths at respective touch areas. The driving signal line 340 may be formed to have a relatively wide width W3 at the bending area 330 suffering relatively great tension according to bending. And the driving signal line 340 may be formed to have a width W1 or W2, narrower than the width W3, at the front touch area 310 or the side touch area 320 suffering relatively small tension. The driving signal line 340 may prevent a crack phenomenon which occurs in forming a width of a signal line widely at the bending area 330. According to various embodiments of the present disclosure, the driving signal line 340 may be formed to have the same width at the front touch area 310 and at the side touch area 320 (i.e., W1=W2).

According to various embodiments of the present disclosure, the driving signal line 340 may be formed to have different widths at the front touch area 310, the side touch area 320, and the bending area 330. The driving signal line 340 may be formed to have a width W1 at the front touch area 310, a width W2 at the side touch area 320, and a width W3 at the bending area 330. The driving signal line 340 may be formed to have the widest width W3 at the bending area 330 suffering the greatest tension according to bending, and to have the narrowest width W1 at the front touch area 310 suffering the smallest tension. And the driving signal line 340 may be formed to have a width, which is narrower than (or narrower than or equal to) the widest width W3 and wider than (or wider than or equal to) the narrowest width W1, at the side touch area 320 (W1<W2<W3).

According to various embodiments of the present disclosure, the width of the driving signal line 340 may be variable within a touch area. For example, a width of a signal line included in the front touch area 310 may be formed widely as a distance from the bending area 330 decreases and may be formed narrowly as a distance from the bending area 330 increases.

According to various embodiments of the present disclosure, a thickness of a signal line may be variable according to a touch area. For example, a thickness D3 of a signal line at the bending area 330 may be formed to be thicker than a thickness D1 of the signal line at the front touch area 310 or a thickness D2 of the signal line 340 at the side touch area 320 (D3>D1 or D3>D2), thereby preventing a crack phenomenon.

In FIG. 4, an embodiment of the present disclosure is exemplified as a touch panel 260 is bent in a progressive direction of the driving signal line 340. However, the scope and spirit of the present disclosure may not be limited thereto. For example, the present disclosure may be applied to the case that the touch panel 260 is bent in a progressive direction of the recognition signal line 350.

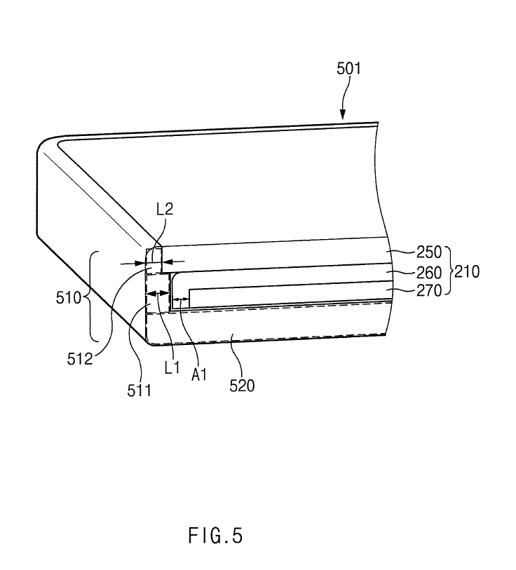

FIG. 5 is a cross-sectional view of an electronic device 501 including a case unit having a step construction.

Referring to FIG. 5, a display module 210 may include a window panel 250, a touch panel 260, and a display panel 270. The display module 210 may be mounted and fixed in a case unit (or an outer housing) 220.

A side portion 510 of the case unit 220 may correspond to stacked panels and may be formed to have a staircase shape. A height of the side portion 510 may be determined according to a height of a bottom portion 520 of the case unit under a display panel 270, a height of a first step 511, or a height of a second step 512.

The height of the first step 511 may be determined to correspond to a panel thickness of a touch panel 260 and a display panel 270. The height of the first step 511 may be greater than or equal to a sum of a thickness of the touch panel 260 and a thickness of the display panel 270. An adhesive layer (not illustrated) may exist between the touch panel 260 and the display panel 270. In this case, the height of the first step 511 may be determined to become greater than a sum of a thickness of the touch panel 260 and a thickness of the display panel 270 in the light of a thickness of an adhesive layer. According to various embodiments of the present disclosure, in the case where the touch panel 260 is bent to surround the display panel 270, the height of the first step 511 may be determined according to a height of a side touch area of the touch panel 260.

The height of the second step 512 may be determined to correspond to a panel thickness of a window panel 250. The height of the second step 512 may be greater than or equal to a thickness of the window panel 250. An adhesive layer (not illustrated) may exist between the window panel 250 and the touch panel 260. In this case, the height of the second step 512 may be determined to become greater than a thickness of the window panel 250 in the light of a thickness of an adhesive layer.

The side portion 510 may have a staircase shape by forming thicknesses of the first step 511 and the second step 512 differently from each other. A thickness L1 of the first step 511 may be thicker than a thickness L2 of the second step 512. A window panel 250 may be laterally expanded from a side of the touch panel 260 by a thickness difference (L1−L2) between the first step 511 and the second step 512. The side portion 510 may improve stability on the mounting of a panel through the staircase shape.

According to various embodiments of the present disclosure, a distance A1 between the side portion 510 and the display panel 270 may be determined according to a curvature of a bending area 330 and a thickness of the touch panel 260. For example, in the case where the curvature of the bending area 330 is small (e.g., in the case where a bending area is smoothly rounded to minimize a crack of a signal line), the distance A1 may be greater than a thickness of the touch panel 260. In this case, each of a front surface and a rear surface of a side touch area may be filled with adhesive material. As another example, in the case where the curvature of the bending area 330 is great (e.g., in the case where rounding is easily performed due to small brittleness of a signal line), the distance A1 may be similar or equal to a thickness of the touch panel 260.

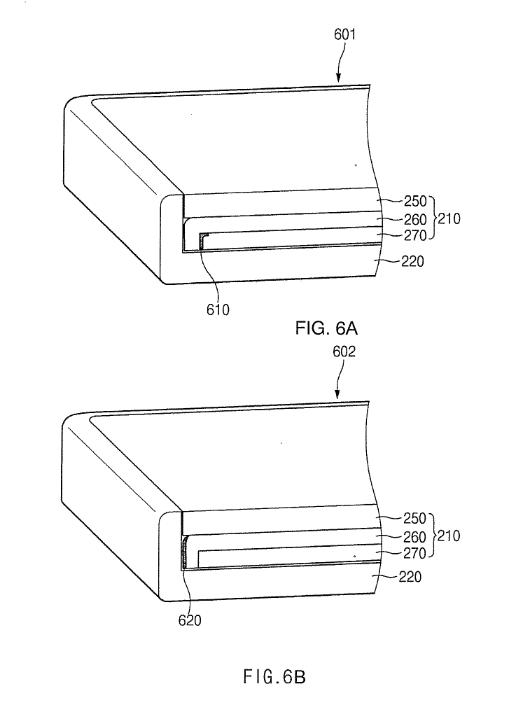

FIG. 6 is a cross-sectional view of an electronic device including a shielding member, according to various embodiments of the present disclosure.

In an electronic device 601, a display module 210 may include a window panel 250, a touch panel 260, and a display panel 270.

The display panel 210 may further include a shielding member 610 between the touch panel 260 and the display panel 270. The shielding member 610 may block electrical influence occurring at the display panel 270, thereby improving a touch recognition performance of the touch panel 260. The shielding member 610 may be implemented using a metal material (e.g., aluminum) and the like.

A side touch area or a bending area of the touch panel 260 may include a sensor for recognizing a touch operation, and the sensor may be affected according to a change in a surrounding electric field. An interconnection area for driving of the display panel 270 may exist at a side portion of the display panel 270. An electric field generated at the interconnection area may cause a touch recognition error at the side touch area. The shielding member 610 may block an electric field generated at the side portion of the display panel 270, thereby preventing a touch recognition error occurring at the side touch area or the bending area of the touch panel 260.

In an electronic device 602, the display module 210 may further include a shielding member 620 between a side portion of a case unit 220 and a side touch area of the touch panel 260. The shielding member 620 may restrict touch recognition of at least a part of the side touch area of the touch panel 260. The shielding member 620 may allow a touch operation of a user to be recognized at a part of the side touch area of the touch panel 260 and not to be recognized at the rest thereof. For example, the shielding member 620 may shield the remaining part other than a specific button (e.g., a power button or a volume button) shape of the side touch area such that the button is implemented in a side touch shape. In this case, the button may be implemented in the form of a touch-type button, not a physical button. Accordingly, it may be possible to implement a simplified design as compared with a physical button.

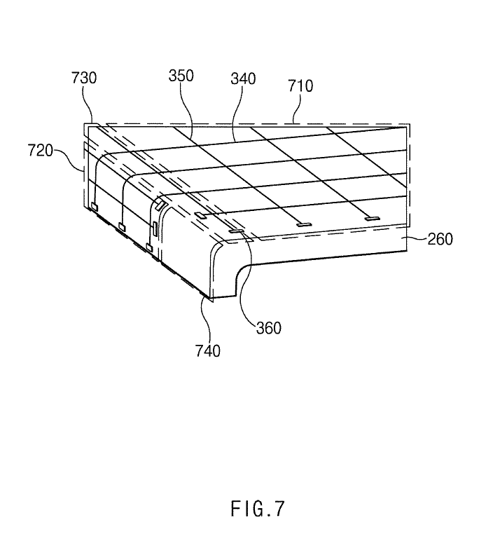

FIG. 7 illustrates a touch panel in which a part of a side touch area is restricted.

Referring to FIG. 7, a touch panel 260 may include a front touch area 710, a side touch area 720, a bending area 730, and a touch limit area 740. Each of the front touch area 710, the side touch area 720, and the bending area 730 may include a signal line for recognizing a touch operation of a user. The signal line may include at least one driving signal line 340 or at least one recognition signal line 350. The touch limit area 740 may correspond to an area that does not include a separate signal line.

The touch limit area 740 may reduce a touch error which occurs when a user holds an electronic device. For example, in the case where a user uses an electronic device such as a smart phone, the touch limit area 740 may be disposed at a bottom end portion of a side of the electronic device. The touch limit area 740 may be disposed at an area which a user touches while holding the electronic device, thereby reducing probability of a device malfunction occurring according to an unnecessary touch.

According to various embodiments of the present disclosure, a side portion of the touch panel 220 may be partitioned into a plurality of zones, and signal line densities of the zones may be different from each other. For example, the side touch area 720 of the touch panel 220 may be partitioned into a first zone, a second zone, and a third zone. Signal lines of which the density is highest may be disposed at the first zone, signal lines of which the density is lower than that of the first zone may be disposed at the second zone. And signal lines of which the density is lower than that of the second zone (i.e., lowest) may be disposed at the third zone. The density of signal lines may be varied according to a design or a need for the use.

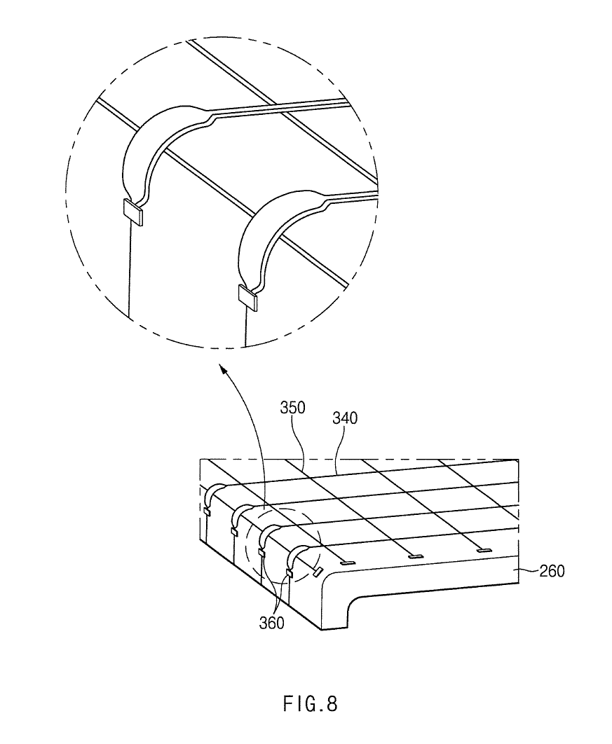

FIG. 8 illustrates a touch panel in which signal lines are expanded into a bending area.

Referring to FIG. 8, each of a front touch area and a bending area of a touch panel 260 may include a signal line for recognizing a touch operation of a user. The signal line may include at least one driving signal line 340 or at least one recognition signal line 350. A side touch area of the touch panel 260 may not include a separate signal line for recognizing a touch operation of a user and may include a pad 360 and an interconnection connected to the pad 360.

Even though made with a signal line shared by a front touch area and a bending area of the touch panel 260, a driving signal line 340 may be implemented to have different widths at touch areas. The driving signal line 340 may be formed to have a relatively wide width at a bending area suffering relatively great tension according to bending and to have a relatively narrow width at a front touch area suffering relatively small tension. For example, a width of the driving signal line 340 may be formed widely at the bending area, thereby preventing a crack occurring at the bending area.

According to various embodiments of the present disclosure, a width of the driving signal line 340 may be variable within a touch area. For example, a width of a signal line included in the front touch area of the touch panel 260 may be formed widely as a distance from the bending area decreases and may be formed narrowly as a distance from the bending area increases.

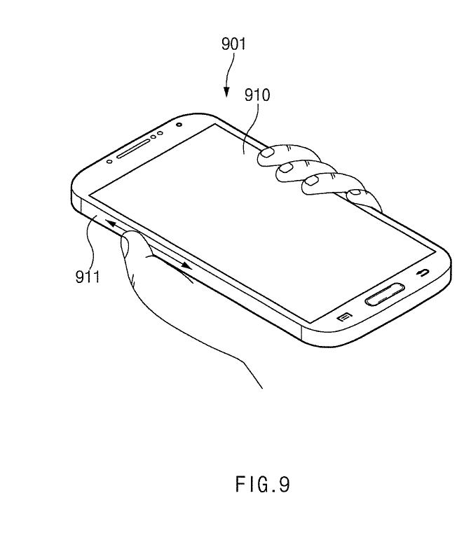

FIG. 9 illustrates an example utilization of an electronic device including a side touch area according to various embodiments of the present disclosure.

Referring to FIG. 9, a user may touch a side touch area 911 to operate an electronic device 901. The electronic device 901 may perform a specific operation based on a side touch operation of a user. For example, in the case where a user touches the side touch area 911 and moves it upward and downward, the electronic device 901 may scroll a screen based on the degree of movement.

As another example, in the case where a user touches the side touch area 911 and moves it upward and downward, the electronic device 901 may change the size of contents displayed at a screen based on the degree of movement.

According to various embodiments of the present disclosure, a button disposed at a side of a electronic device may be implemented in a touch manner through a side touch of the electronic device 901. For example, if a user pushes a specific point over a predetermined time, the electronic device 901 may perform the same operation as the pushing of a conventional power button. According to various embodiments of the present disclosure, if a user pushes a specific point over a predetermined time, the electronic device 901 may perform entering into a camera. As another example, if a user pushes a specific point while a camera operation is being performed, the electronic device 901 may perform a camera shutter function. According to various embodiments of the present disclosure, if a user double taps a specific point within a predetermined range, the electronic device 901 may activate a volume control function. A design of the electronic device 901 may be simplified by removing a physical button disposed at a side thereof.

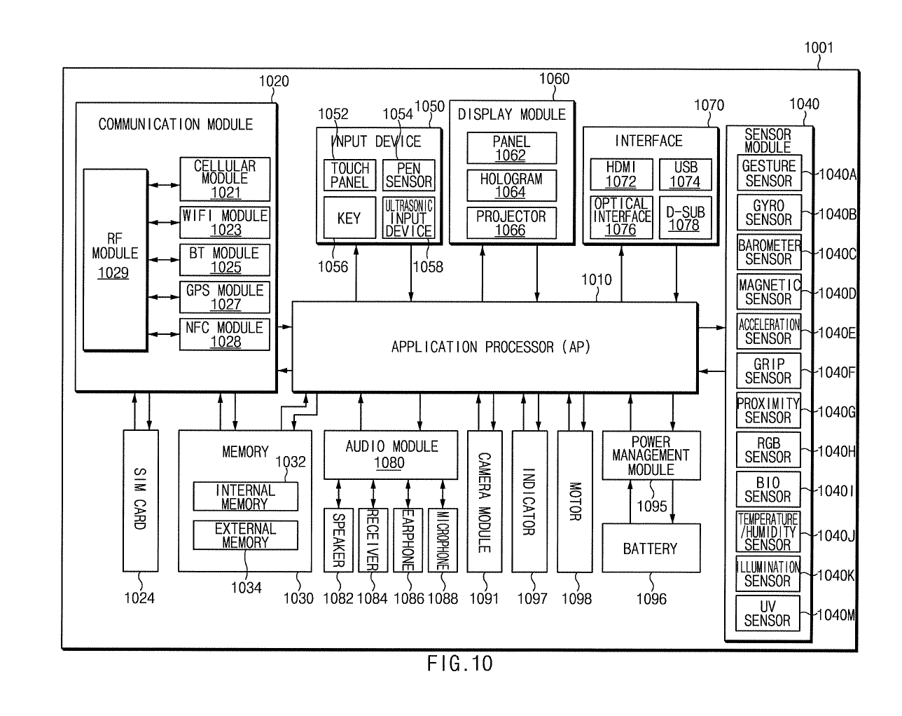

FIG. 10 illustrates an electronic device 1001 according to various embodiments of the present disclosure. An electronic device 1001 may include the whole or a part of an electronic device 101 illustrated in FIG. 1.

Referring to FIG. 10, an electronic device 1001 may include one or more application processors (AP) 1010, a communication module 1020, a subscriber identification module (SIM) card 1024, a memory 1030, a sensor module 1040, an input device 1050, a display 1060, an interface 1070, an audio module 1080, a camera module 1091, a power management module 1095, a battery 1096, an indicator 1097, and a motor 1098.

The AP 1010 may drive an operating system (OS) or an application to control a plurality of hardware or software components connected to the AP 1010 and may process and compute a variety of data including multimedia data. The AP 1010 may be implemented with a System on Chip (SoC), for example. According to an embodiment of the present disclosure, the AP 1010 may further include a graphic processing unit (GPU) (not illustrated).

The communication module 1020 may transmit and receive data when there are conveyed communications between other electronic devices connected with the electronic device 1001 through a network. According to an embodiment of the present disclosure, the communication module 1020 may include a cellular module 1021, a wireless-fidelity (Wi-Fi) module 1023, a Bluetooth (BT) module 1025, a global positioning system (GPS) module 1027, a near field communication (NFC) module 1028, and a radio frequency (RF) module 1029.

The cellular module 1021 may provide voice communication, video communication, a character service, an Internet service or the like through a communication network (e.g., an LTE, an LTE-A, a CDMA, a WCDMA, a UMTS, a WiBro, a GSM, or the like). Also, the cellular module 1021 may perform discrimination and authentication of an electronic device within a communication network using a subscriber identification module (e.g., a SIM card 1024), for example. According to an embodiment of the present disclosure, the cellular module 1021 may perform at least a portion of functions that the AP 1010 provides. For example, the cellular module 1021 may perform at least a portion of a multimedia control function.

According to an embodiment of the present disclosure, the cellular module 1021 may include a communication processor (CP). Also, the cellular module 1021 may be implemented with, for example, a SoC. Although components such as the cellular module 1021 (e.g., a communication processor), the memory 1030, the power management module 1095, and the like are illustrated as being components independent of the AP 1010, the AP 1010 may be implemented to include at least a portion (e.g., a cellular module 1021) of the above components.

According to an embodiment of the present disclosure, the AP 1010 or the cellular module 1021 (e.g., a communication processor) may load and process an instruction or data received from nonvolatile memories respectively connected thereto or from at least one of other elements at the nonvolatile memory. Also, the AP 1010 or the cellular module 1021 may store data received from at least one of other elements or generated by at least one of other elements at a nonvolatile memory.

Each of the Wi-Fi module 1023, the BT module 1025, the GPS module 1027, and the NFC module 1028 may include a processor for processing data exchanged through a corresponding module, for example. In FIG. 10, an embodiment of the present disclosure is exemplified as the cellular module 1021, the Wi-Fi module 1023, the BT module 1025, the GPS module 1027, and the NFC module 1028 are separate blocks, respectively. According to an embodiment of the present disclosure, at least a portion (e.g., two or more components) of the cellular module 1021, the Wi-Fi module 1023, the BT module 1025, the GPS module 1027, and the NFC module 1028 may be included within one Integrated Circuit (IC) or an IC package. For example, at least a portion (e.g., a communication processor corresponding to the cellular module 1021 and a Wi-Fi processor corresponding to the Wi-Fi module 1023) of communication processors corresponding to the cellular module 1021, the Wi-Fi module 1023, the BT module 1025, the GPS module 1027, and the NFC module 1028 may be implemented with one SoC.

The RF module 1029 may transmit and receive data, for example, an RF signal. Although not illustrated, the RF module 1029 may include a transceiver, a power amplifier module (PAM), a frequency filter, or low noise amplifier (LNA). Also, the RF module 1029 may further include the following part for transmitting and receiving an electromagnetic wave in a space in wireless communication: a conductor or a conducting wire. In FIG. 10, an embodiment of the present disclosure is exemplified as the cellular module 1021, the Wi-Fi module 1023, the BT module 1025, the GPS module 1027, and the NFC module 1028 are implemented to share one RF module 1029. According to an embodiment of the present disclosure, at least one of the cellular module 1021, the Wi-Fi module 1023, the BT module 1025, the GPS module 1027, or the NFC module 1028 may transmit and receive an RF signal through a separate RF module.

The SIM card 1024 may be a card that includes a subscriber identification module and may be inserted to a slot formed at a specific position of the electronic device. The SIM card 1024 may include unique identify information (e.g., integrated circuit card identifier (ICCID)) or subscriber information (e.g., integrated mobile subscriber identity (IMSI)).

The memory 1030 (e.g., the memory 730) may include an embedded memory 1032 or an external memory 1034. For example, the embedded memory 1032 may include at least one of a volatile memory (e.g., a dynamic random access memory (DRAM), a static RAM (SRAM), or a synchronous DRAM (SDRAM)) and a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory).

According to an embodiment of the present disclosure, the internal memory 1032 may be a solid state drive (SSD). The external memory 1034 may include a flash drive, for example, compact flash (CF), secure digital (SD), micro secure digital (Micro-SD), mini secure digital (Mini-SD), extreme digital (xD) or a memory stick. The external memory 1034 may be functionally connected to the electronic device 1001 through various interfaces. According to an embodiment of the present disclosure, the electronic device 1001 may further include a storage device (or a storage medium), such as a hard drive.

The sensor module 1040 may measure a physical quantity or may detect an operation state of the electronic device 1001. The sensor module 1040 may convert the measured or detected information to an electric signal. The sensor module 1040 may include at least one of a gesture sensor 1040A, a gyro sensor 1040B, a pressure sensor 1040C, a magnetic sensor 1040D, an acceleration sensor 1040E, a grip sensor 1040F, a proximity sensor 1040G, a color sensor 1040H (e.g., red, green, blue (RGB) sensor), a living body sensor 1040I, a temperature/humidity sensor 1040J, an illuminance sensor 1040K, or an UV sensor 1040M. Although not illustrated, additionally or generally, the sensor module 1040 may further include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 1040 may further include a control circuit for controlling at least one or more sensors included therein.

The input device 1050 may include a touch panel 1052, a (digital) pen sensor 1054, a key 1056, or an ultrasonic input unit 1058. The touch panel 1052 may recognize a touch input using at least one of capacitive, resistive, infrared and ultrasonic detecting methods. Also, the touch panel 1052 may further include a control circuit. In the case of using the capacitive detecting method, a physical contact recognition or proximity recognition may be allowed. The touch panel 1052 may further include a tactile layer. In this case, the touch panel 1052 may provide a tactile reaction to a user.

The (digital) pen sensor 1054 may be implemented in a similar or same manner as the method of receiving a touch input of a user or may be implemented using an additional sheet for recognition. The key 1056 may include, for example, a physical button, an optical key, a keypad, and the like. The ultrasonic input device 1058, which is an input device for generating an ultrasonic signal, may enable the electronic device 1001 to sense detect a sound wave through a microphone (e.g., a microphone 1088) so as to identify data, wherein the ultrasonic input device 1058 is capable of wireless recognition. According to an embodiment the present disclosure, the electronic device 1001 may use the communication module 1020 so as to receive a user input from an external device (e.g., a computer or server) connected to the communication module 1020.

The display 1060 (e.g., a display 150) may include a panel 1062, a hologram device 1064, or a projector 1066. The panel 1062 may be, for example, a liquid crystal display (LCD), an active matrix organic light-emitting diode (AM-OLED, or the like. The panel 1062 may be, for example, flexible, transparent or wearable. The panel 1062 and the touch panel 1052 may be integrated into a single module. The hologram device 1064 may display a stereoscopic image in a space using a light interference phenomenon. The projector 1066 may project light onto a screen so as to display an image. The screen may be arranged in the inside or the outside of the electronic device 1001. According to an embodiment of the present disclosure, the display 1060 may further include a control circuit for controlling the panel 1062, the hologram device 1064, or the projector 1066.

The interface 1070 may include, for example, an HDMI (high-definition multimedia interface) 1072, a USB (universal serial bus) 1074, an optical interface 1076, or a D-sub (D-subminiature) 1078. The interface 1070 may be included, for example, in a communication module 160 illustrated in FIG. 1. Additionally or generally, the interface 1070 may include, for example, a mobile high definition link (MHL) interface, a SD card/multi-media card (MMC) interface, or an infrared data association (IrDA) standard interface.

The audio module 1080 may convert a sound and an electric signal in dual directions. At least a portion of the audio module 1080 may be included, for example, in an input/output interface 140 illustrated in FIG. 1. The audio module 1080 may process, for example, sound information that is input or output through a speaker 1082, a receiver 1084, an earphone 1086, or a microphone 1088.

According to an embodiment of the present disclosure, the camera module 1091 for shooting a still image or a video may include at least one image sensor (e.g., a front sensor or a rear sensor), a lens (not illustrated), an image signal processor (ISP, not illustrated), or a flash (e.g., an LED or a xenon lamp, not illustrated).

The power management module 1095 may manage power of the electronic device 1001. Although not illustrated, a power management integrated circuit (PMIC) a charger IC, or a battery or fuel gauge may be included in the power management module 1095.

The PMIC may be mounted on an integrated circuit or a SoC semiconductor. A charging method may be classified into a wired charging method and a wireless charging method. The charger IC may charge a battery, and may prevent an overvoltage or an overcurrent from being introduced from a charger. According to an embodiment of the present disclosure, the charger IC may include a charger IC for at least one of the wired charging method and the wireless charging method. The wireless charging method may include, for example, a magnetic resonance method, a magnetic induction method or an electromagnetic method, and may include an additional circuit, for example, a coil loop, a resonant circuit, or a rectifier, and the like.

The battery gauge may measure, for example, a remaining capacity of the battery 1096 and a voltage, current or temperature thereof while the battery is charged. The battery 1096 may store or generate electricity, and may supply power to the electronic device 1001 using the stored or generated electricity. The battery 1096 may include, for example, a rechargeable battery or a solar battery.

The indicator 1097 may display a specific state of the electronic device 1001 or a portion thereof (e.g., the AP 1010), such as a booting state, a message state, a charging state, and the like. The motor 1098 may convert an electrical signal into a mechanical vibration. Although not illustrated, a processing device (e.g., a GPU) for supporting a mobile TV may be included in the electronic device 1001. The processing device for supporting a mobile TV may process media data according to the standards of DMB, digital video broadcasting (DVB) or MediaFlo™.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations.

According to various embodiments of the present disclosure, an electronic device may include a window panel, a touch panel of which at least a part is bent to be partitioned into a first touch area or a second touch area, and a display panel. The touch panel may include a driving signal line or a recognition signal line, and each of the first and second touch areas may include at least one of the driving signal line or the recognition signal line. The driving signal line may be disposed in a first direction to apply a power, and the recognition signal line may be disposed in a second direction perpendicular to the first direction and may recognize a change in an electrical signal according to a touch operation of a user.

The driving signal line or the recognition signal line may be disposed within a specific range of the second touch area. The driving signal line or the recognition signal line may be implemented using at least one of metal mesh, silver nano tube, carbon nano tube (CNT), or graphene.

According to various embodiments of the present disclosure, the touch panel may further include a bending area between the first and second touch areas, and the bending area may include at least one of the driving signal line or the recognition signal line. The bending area may include a signal line of which the width is wider than that of the driving signal line or the recognition signal line of the first or second touch area. In the first and second touch areas, a width of a driving signal line or a recognition signal line may become wider as a distance from the bending area decreases.

According to various embodiments of the present disclosure, the electronic device may further include a shielding member between the touch panel and the display panel, and the shielding member may block an electric field occurring at the display panel.

The first touch area may be disposed in parallel with the window panel or the display panel. The second touch area may be disposed to be perpendicular to the first touch area. At least a part of the display panel may be implemented with a flexible material and is bent.

According to various embodiments of the present disclosure, a touch panel may include a first touch area, and a second touch area bent from the first touch area and expanded. Each of the first and second touch areas may include at least one of a driving signal line or a recognition signal line for recognizing a touch operation of a user.

The touch panel may further include a bending area disposed between the first and second touch areas, and the bending area may include at least one of the driving signal line or the recognition signal line. The bending area may include a signal line of which the width is wider than that of the driving signal line or the recognition signal line of the first or second touch area. In the first and second touch areas, a width of a driving signal line or a recognition signal line may become wider as a distance from the bending area decreases.

Although the present disclosure has been described with embodiments, various changes and modifications may be suggested to one skilled in the art. It is intended that the present disclosure encompass such changes and modifications as fall within the scope of the appended claims.

What is claimed is:

1. An electronic device, comprising:
a window panel;
a touch panel of which at least a part is bent, partitioning the touch panel into a first touch area and a second touch area, wherein the touch panel comprises at least one signal line, and wherein each of the first and second touch areas comprises the at least one signal line, and wherein each signal line includes a driving signal line or a recognition signal line; and
a display panel.

2. The electronic device of claim 1, wherein each driving signal line is disposed in a first direction and is configured to apply power, and
wherein each recognition signal line is disposed in a second direction perpendicular to the first direction and is configured to recognize a change in an electrical signal according to a touch input of a user.

3. The electronic device of claim 1, wherein the at least one signal line of the second touch area is disposed within a specific range of the second touch area.

4. The electronic device of claim 1, wherein each driving signal line or each recognition signal line is implemented using at least one of metal mesh, silver nano tube, carbon nano tube (CNT), or graphene.

5. The electronic device of claim 1, wherein the touch panel further comprises a bending area between the first and second touch areas, and
wherein the bending area comprises some of the at least one signal line.

6. The electronic device of claim 5, wherein the some of the at least one signal line of the bending area comprises a signal line of which a width is wider than that of:
the driving signal line,
the recognition signal line of the first touch area, or
the recognition signal line of the second touch area.

7. The electronic device of claim 5, wherein in the first and second touch areas, a width of a driving signal line or a recognition signal line widens as a distance from the bending area decreases.

8. The electronic device of claim 1, further comprising:
a shielding member between the touch panel and the display panel, and
wherein the shielding member is configured to block an electric field occurring at the display panel.

9. The electronic device of claim 1, wherein the first touch area is disposed parallel with the window panel or the display panel.

10. The electronic device of claim 1, wherein the second touch area is disposed perpendicular to the first touch area.

11. The electronic device of claim 1, wherein at least a part of the display panel is implemented with a flexible material and is bent.

12. A touch panel, comprising:
a first touch area; and
a second touch area bent from the first touch area and expanded,
wherein each of the first and second touch areas comprises at least one signal line configured to recognize a touch of a user, and wherein each signal line includes a driving signal line or a recognition signal line.

13. The touch panel of claim 12, further comprising;
a bending area disposed between the first and second touch areas, and
wherein the bending area comprises at least one signal line.

14. The touch panel of claim 13, wherein the bending area comprises a signal line of which a width is wider than that of a driving signal line or a recognition signal line of the first or second touch area.

15. The touch panel of claim 13, wherein in the first and second touch areas, a width of a driving signal line or a recognition signal line widens as a distance from the bending area decreases.

16. The touch panel of claim 12, wherein each driving signal line is disposed in a first direction and is configured to apply power, and
wherein each recognition signal line is disposed in a second direction perpendicular to the first direction.

17. The touch panel of claim 12, wherein the at least one signal line of the second touch area is disposed within a specific range of the second touch area.

18. The touch panel of claim 12, wherein each driving signal line or each recognition signal line is implemented using at least one of metal mesh, silver nano tube, carbon nano tube (CNT), or graphene.

19. An electronic device, comprising:
a window panel;
a touch panel of which at least a part is bent, partitioning the touch panel into a first touch area and a second touch area, wherein the touch panel comprises at least one signal line, and wherein each of the first and second touch areas comprises the at least one signal line, and wherein each signal line includes a driving signal line or a recognition signal line;
a display panel; and
a case unit having a step construction.

20. The electronic device of claim 19, wherein the step construction includes:
a first step having a first thickness from a side portion of the electronic device to a side portion of the touch panel, and
a second step having a second thickness from the side portion of the electronic device to a side portion of the window panel,
wherein the first thickness is greater than the second thickness, and
wherein the touch panel is layered between the window panel and the display panel.
